(19) United States
(12) Patent Application Publication
(10) Pub. No.: US 2022/0202549 A1
(43) Pub. Date: Jun. 30, 2022

(54) Breath Elude

(71) Applicants: Christie Stevenson, Mesquite, TX (US); Michael Myles, Metairie, LA (US)

(72) Inventors: Christie Stevenson, Mesquite, TX (US); Michael Myles, Metairie, LA (US)

(21) Appl. No.: 17/139,182

(22) Filed: Dec. 31, 2020

(51) Int. Cl. A61C 19/06; A61Q 11/00

(52) U.S. Cl. CPC A61C 19/063; A61Q 11/00

(57) ABSTRACT

An oral hygiene device designed to allow the user to cleanse the breath and kill germs in the oral cavity is disclosed. The oral hygiene device comprises a holder, an enclosure, and one or more breath freshener. The device is a polished plastic product configured to load with the freshener strip in the enclosure. The device is incorporated in the user mouth using the holder comprising a curved tabs fitting between the teeth and gums. The breath freshener via one or more holes in the enclosure configured to dissolve when subjected to the saliva within the mouth and exhibits controlled release of a cleansing chemicals and flavor in the freshener strips in the user mouth.

### BACKGROUND OF THE INVENTION

### A. Technical Field

The present invention generally relates to an oral hygiene device and method for eluding the bad breath using the oral hygiene device.

### B. Description of Related Art

Generally, the preponderance of bad breath is caused by volatile sulfur compounds within the mouth cavity and stale biofilm on the back of the tongue determined by the dental sciences. A significant portion of the offensive portion of the bad breath is caused by the stale biofilm on the tongue. Without eliminating this biofilm, and significant halitosis contributor, bad breath continues regardless of rinses, gum, and other flavorful cloaking odorants.

Certain foods can be especially offensive such as garlic, onions, and raw broccoli and other food items are known to cause bad breath. Tobacco products are also known to be offensive to the breath. However, the medical reasons for bad breath includes dry mouth, medications, infections, chronic reflux and other nose and throat conditions. Some of these conditions are unavoidable, and only solution would be a constant freshening of the breath while in social situations with other people. Typically, breath fresheners are offered in the usages of mouthwash, flavored mints, gum, or any number of marketed oral fresheners. Most of these fresheners are unavailable or not used on a consistent basis while he or she is attending meetings or talking with people. Encounters at parties and meeting with people can often take hours thereby it would be unusual to have the place or take the time to use a mouthwash.

Appearing at your best in social situations whether encountering strangers, new acquaintances or when just talking and meeting with friends, an important part of creating an impression is personal hygiene. Naturally, cleaning and showering regularly is essential as is cleaning one's teeth every day. However, refreshing the mouth by brushing and cleaning is not always available for many people when visiting, and talking with other people. Often meetings and social situations take place far from home, after hours, and away from facilities for refreshing the mouth, for example, especially after eating a meal or eating snacks. The usage of a breath freshener to ward away the dreaded aspect of halitosis or bad breath is also an indispensable practice for anyone wishing to unoffended anyone with his or her breath. Mouth sprays, gum, mints and other oral freshening products are often inappropriate for the social setting. Further, these products offer only a temporary solution to the oral hygienic problem.

Therefore, there is a need for an oral hygiene device providing long lasting fresh breath without revealing its usage to the listeners. Further, there is a need for an oral hygiene device, which is capable of providing confidence to the users on their breath, while speaking, attending a meeting or a conference.

### SUMMARY OF THE INVENTION

The present invention relates to an oral hygiene device, designed to allow the user to cleanse breathe and kill germs in the oral cavity. In an embodiment, the oral hygiene device comprises a holder, an enclosure, and one or more breath freshener. In one embodiment, the holder having curved edges and tabs are gently rounded, which could provide comfort within the mouth after insertion. The holder is made of a food grade polypropylene plastic by injection molding process. After molding process, the holder is subjected to high frequency vibrational deburring, where the appliance is polished without changing the contours and configuration of the product. After deburring, the holder is washed, disinfected, hot air dried, and then sealed in a sterile poly-film enclosure, which is backfilled with nitrogen. The holder is thermally sealed for germ free protection until the initial use. The holder could be supplied in any vibrant color, so a distinctive color may be chosen to enhance the product recognition factor. The device could be produced in a flesh color that allows blending into the mouth coloration. In one embodiment, the holder is attached to the enclosure of the device by an adhesive or a fastening mechanism. In another embodiment, the holder is integrated to the enclosure of the device.

In one embodiment, the tab integrally extending from an end of the holder to secure the enclosure between the teeth of the wearer. In one embodiment, the tab is adapted to user's teeth conformation. However, some additional care will have to be taken to clean these slots routinely to prevent biofilm build up in this design features.

In an embodiment, the enclosure is a protective package holds the breath freshener is injection molded from the polypropylene plastic. The enclosure is made of durable plastic, chemical resistant, and easily cleaned using soap and water. The enclosure could be produced in any tinted color, so a distinctive color may be chosen to enhance the product recognition factor. The enclosure could be produced in a colorless translucent material, so the breath freshener inside could be observed. The enclosure could be made with two adjoined cavities, where one side contains the breath freshener and the other side conveniently holds the device until it is required for use.

In one embodiment, the breath freshener are sugar free strips prepared using human compatibility and safe chemicals. The breath fresheners are formulated to be a slow or controlled time-release of the flavor or odorant, and germ or oral biofilm killing chemicals. The efficacy of the breath freshener is designed to sustain from one to two hours in mouth, where normal saliva levels are present. The breath fresheners are relatively thick and breakable so they could be easily placed in the device. While there are many formulations that can be made available, this example consists of, but is not limited to, the chemicals used for aroma or flavor, dye or colors such as green, blue, etc., carrageenan, copper gluconate, eucalyptol, glyceryl oleate, gum such as locust bean, xanthan, etc. The flavor includes peppermint, spearmint, cinnamon, citrus, strawberry, grape, watermelon, apple, and vanilla, etc. In some embodiments, the breath freshener includes any one of an edible film, orally dissolving strip, chewing gum, tablet, lozenge, liquid, hard candy and a gel.

The oral hygiene device is designed to be aesthetic and effective in the application. The oral hygiene device is constructed by simple fabrication, which could be reasonably priced in the market to benefit from fresher breath and improved oral health.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1A shows a schematic view of the oral hygiene device to be fitted into the user's mouth for eluding the bad breath according to an embodiment.

FIG. 1B shows a schematic view of the oral hygiene device fitted into the user's mouth for eluding the bad breath according to an embodiment.

FIG. 2A shows a side view of the oral hygiene device attaching to the user tooth according to an embodiment.

FIG. 2B shows top view of the oral hygiene device according to an embodiment.

FIG. 2C shows side view of the oral hygiene device exposing towards user tongue according to an embodiment.

FIG. 3A shows a top view of a breath freshener used in the device according to an embodiment.

FIG. 3B shows a side view of a breath freshener used in the device according to an embodiment.

FIG. 4A shows a front view of a store case for the freshener strip according to an embodiment.

FIG. 4B shows a side view of a store case for the freshener strip according to an embodiment.

FIG. 5 illustrates a side view of the flexible holder and breath freshener according to an embodiment of the present invention.

FIG. 6 illustrates a top view of the flexible holder and breath freshener according to an embodiment of the present invention.

FIG. 7 illustrates a side view of the breath freshener according to an embodiment of the present invention.

FIG. 8 illustrates a top view of the breath freshener according to an embodiment of the present invention.

FIG. 9 illustrates a top view of the holder enclosure according to an embodiment of the present invention.

FIG. 10 illustrates a side view of the holder enclosure according to an embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

An oral hygiene device designed to allow the user to cleanse the breath and kill germs in the oral cavity is disclosed. The oral hygiene device comprises a holder, an enclosure, and at least one breath freshener. The device is a polished plastic product configured to load with the at least one breath freshener in the enclosure. The device is incorporated in the user mouth using the holder comprising a thin tabs fitting between the teeth and gums. The breath freshener via one or more openings of the enclosure configured to dissolve when subjected to the saliva within the mouth and exhibits controlled release of a cleansing chemicals and flavor from the freshener in the user mouth.

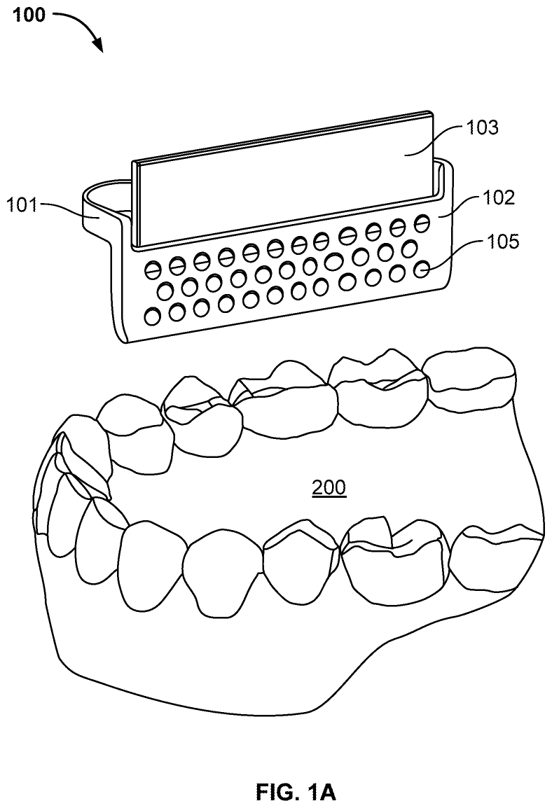

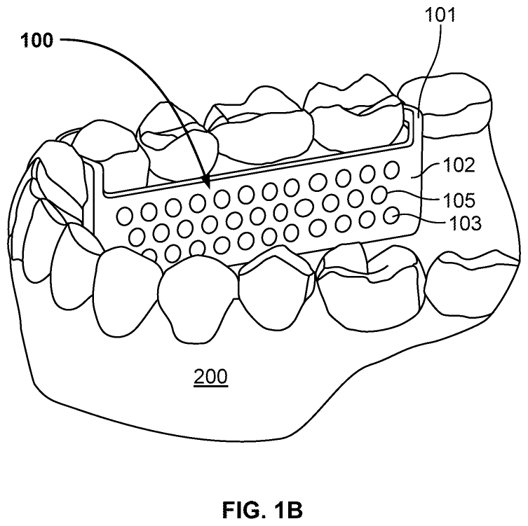

Referring to FIG. 1A and FIG. 1B, the oral hygiene device 100 comprises a holder 101, an enclosure enclosure 102, and one or more breath freshener 103. In an embodiment, the holder 101 having curved edges and thin retention tabs 106 are gently rounded, so there will be no sharp edges, which could cause discomfort within the mouth 200 after insertion. In one embodiment, the holder 101 is made of food grade polypropylene plastic by injection molding process. After molding process, the holder 101 is subjected to high frequency vibrational deburring, where the holder 101 is polished without changing the contours and configuration. After deburring, the holder 101 is washed, disinfected, hot air dried, and then sealed in a sterile poly-film enclosure, which is backfilled with nitrogen. The holder 101 is thermally sealed for germ free protection until the initial use. The holder 101 could be supplied in any vibrant color, so a distinctive color may be chosen to enhance the product recognition factor. The holder 101 could be produced in a flesh color that allows blending into the mouth coloration.

In some embodiments, the tabs 106 could be attached to the holder 101 at one end by an adhesive or a fastening mechanism, allowing them to be moved together or apart to fit user's teeth 200 conformation. However, some additional care will have to be taken to clean these slots routinely to prevent biofilm formation.

In an embodiment, the enclosure 102 is a protective packaging, holds the breather freshener 103 is injection molded from the polypropylene plastic. In one embodiment, the enclosure 102 is made of durable plastic. In another embodiment, the enclosure is a chemical resistant material or coated by a chemical resistant material. The enclosure 102 could be produced in any tinted color, so a distinctive color may be chosen to enhance the product recognition factor. The enclosure 102 could be produced in a colorless translucent material, so the breath freshener inside could be observed. The enclosure 102 could be made with two adjoined cavities, where one side contains controlled time-release chemical breath freshener and the other side conveniently holds the device until it is required for use. In one embodiment, the device 100 is molded using food grade polypropylene plastic with a plurality of recess 105 exposing towards tongue side in the user mouth to promote diffusion of the breath freshener 103. The user can ingest and chew food without removing the device 100, as the tabs 106 do not occlude the teeth chewing surfaces.

In one embodiment, the breath freshener 103 includes any one of an edible film, orally dissolving strip, chewing gum, tablet, lozenge, liquid, hard candy and a gel. In one embodiment, the breath fresher 103 is a sugar free strips prepared using human compatibility and safe chemicals. The breath freshener 103 are formulated to be a slow or controlled time-release of the flavor or odorant, and germ or oral biofilm killing chemicals. The efficacy of the breath freshener 103 is designed to sustain from one to two hours in mouth, considering the secretion of normal saliva levels. The breath freshener 103 are relatively thick so they could be easily placed in the device 100. While there are many formulations that can be made available, this example consists of, but is not limited to, the chemicals used for aroma or flavor, dye or colors such as green, blue, etc., carrageenan, copper gluconate, eucalyptol, glyceryl oleate, gum such as locust bean, xanthan, etc. The flavor of the breath freshener includes peppermint, spearmint, cinnamon, citrus, strawberry, grape, watermelon, apple, and vanilla, etc. The oral hygiene device 100 is designed to be aesthetic and effective in the application. The oral hygiene device 100 is constructed by simple fabrication, which could be reasonably priced in the market to benefit from fresher breath and improved oral health.

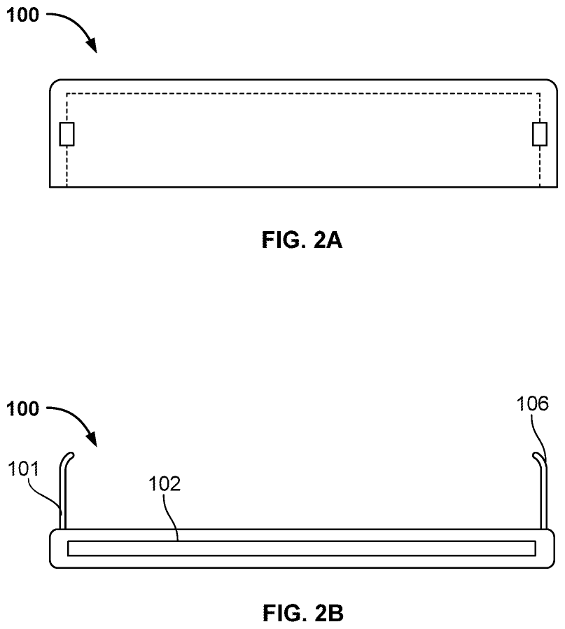

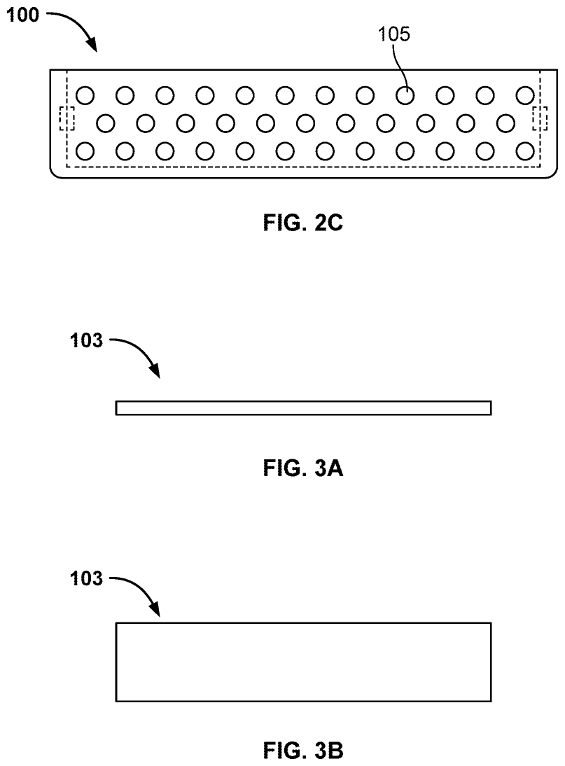

Referring to a side view of the device 100 attaching to the tooth in FIG. 2A, the rear side of the device 100 attached to the mouth is solid, so no breath freshener is captured behind it. The surfaces are polished to insure the device 100 will not irritate the gums even when worn for several hours at a time.

Referring to the top view of the device 100 in FIG. 2B, the device 100 is secured in the mouth using the holder 101 comprises tabs 106 to hold through the teeth and gums. The tabs 106 of holder 101 are slightly curved, and compliant enough to straighten while being inserted between the bottom of the tooth crown and the gum line of the user. Further, the tabs 106 is configured to curved and flexible to retain the device 100 against the tooth and gums. This loose fit allows the device 100 to be comfortable for long duration of use yet be retained in place out of the way of the tongue and chewing surfaces. The small slot of the enclosure 102 of the device 100 accepts the controlled release or time-release breath freshener 103 and holds it in place until fully dissolved.

Referring to another side view of the device 100 exposing to the tongue side of the user mouth in FIG. 2C, the device 100 is molded using food grade polypropylene plastic with a plurality of recess 105 exposing towards tongue side in the user mouth to promote diffusion of the breath freshener 103. The user can ingest and chew food without removing the device 100, as the tabs 106 (shown in FIG. 2B) do not occlude the teeth chewing surfaces. In an embodiment, the device 100 comprises a flesh-colored plastic form that fits in the mouth, where the device 100 fits comfortably between the gum and teeth/tongue in the user mouth 200. In one embodiment, the device 100 comprises the enclosure 102 with two holders 101 such as hooks provided that fit to placing them between the teeth, but not limited to upper or lower teeth. The enclosure 102 is provided with a slot that accept the breath freshener 103 to freshen the breath or mouth. The plurality of recesses 105 on the side of the enclosure 102 faces the tongue. These pluralities of recesses 105 provide flow for the breath freshener 103 of breath freshening material for controlled diffusion into the user mouth 200.

Referring to a top view of the breather freshener 103 used in the device 100 shown in FIG. 3A, the breath freshener 103 fit into the opening in the oral hygiene device 100. The breath freshener 103 are controlled or time release, so the flavor and germ killers are released over time to improve the breath. Referring to a side view of the breath freshener 103 used in the device 100 shown in FIG. 3B, the device 100 is easily removed from the mouth for easy loading of the breath fresheners 103.

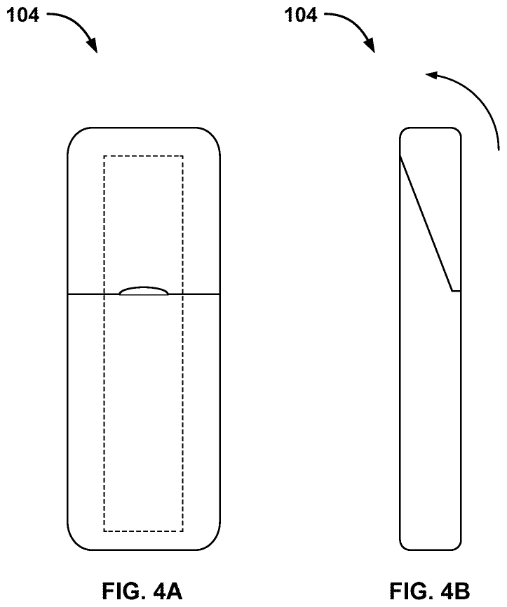

Referring to a front view of a store case 104 for the breath freshener 103 shown in FIG. 4A, the store case 104 are injection molded using food grade plastic to hold and protect the breath freshener 103. The food grade plastic is translucent so the user could see the color of the product. Referring to a front view of the store case 104 for the breath freshener 103 shown in FIG. 4B, the store case 104 has a living hinge that allows the protective door to flex up and allow easy access to the breath freshener 103. The store case 104 could be added with a logo, designs, and hot stamped with custom labels for schools, companies, or other organizations.

The oral hygiene device 100 incurs low cost and increases the ability to keep breath fresh consistently for the users. The device 100 is easy and comfortable to wear, and remove from the user's mouth. The device 100 provides durable workability, which gives more confidence for the users. Further, the device 100 could be an alternative for the users suffering from the medical conditions with bad breath. By fitting the device 100 in the mouth in this manner, it provides constant breath refreshment to the user for longer period. The breath freshener 103 that fit into the device 100 are available in a variety of flavors for the improving breath freshness in the user's mouth.

The pre-manufactured breath freshener 103 could be replaced in the device 100 at any time simply by placing a new breath freshener 103 in when the current one has dissolved. The device 100 is situated in such a way in the mouth 200 that it does not interfere with the function of the teeth. Chewing and eating is possible without removing the device from the mouth 200. The device 100 fits comfortably in the mouth 200 and undetectable by anyone else other than the user. The hidden or invisibility feature of the device 100 to other people while in-use provides the user the ability to refresh their breath without anyone knowledge.

FIGS. 5-10 illustrate another embodiment of the present invention. FIG. 5 illustrates a side view of the breath freshener 103 and the flexible holder 201 of the present invention.

The flexible holder 201 may be formed from porous materials such as polylactic acid polymer resin melt being spun into fibers and then woven into a filter medium and may include a central cavity 203 which may contain the breath freshener 103. The flexible holder 201 may include elongated ends 205 which may be used as handles to manipulate the flexible holder 201. The porous flexible holder 201 allows the saliva to enter the porous flexible holder 201 and the central cavity 203 dissolving the breath freshener 103 which may in turn exit the porous flexible holder 201 and enter the mouth cavity of the user.

FIG. 6 illustrates a top view of the flexible holder 201 and the breath freshener 103. When the breath freshener 103 has been dissolved, the now empty flexible holder 201 may be removed from the mouth and discarded into the trash. The flexible holder 201 may be the biodegradable within months by microorganisms found in the soil. The flexible holder 201 may allow the breath freshener to slowly dissolve within the mouth of the user. The flexible holder 201 may be sized to include multiple breath fresheners 103.

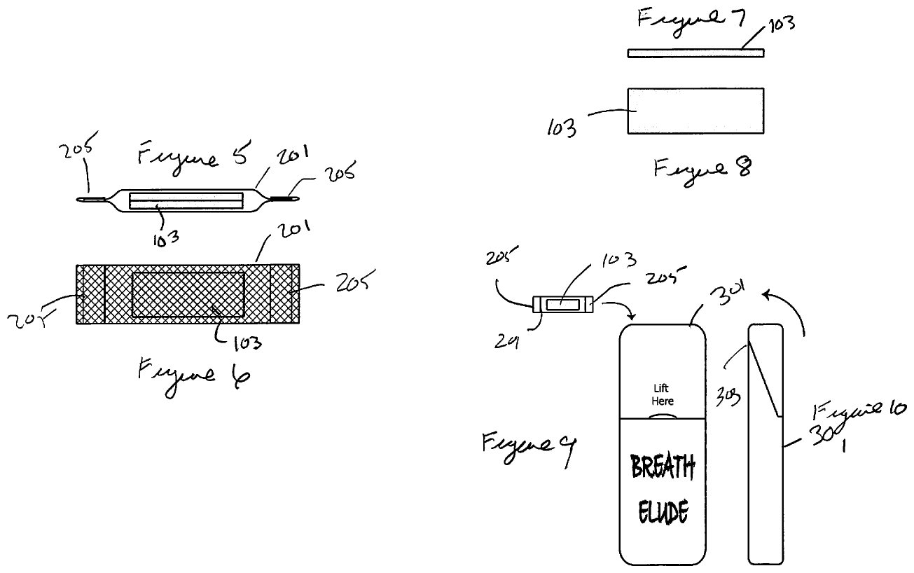

FIG. 7 illustrates a side view of the breath freshener 103 which may be substantially rectangular in shape but, could be oval, circular, triangular or other shapes. The breath freshener 103 may be time-released to allow the flavor and germ killing components of the breath freshener 103 over time dramatically increasing the effectiveness of the breath freshener 103. FIG. 8 illustrates a top view breath freshener 103.

FIG. 9 illustrates a top view of the holder enclosure 301, and FIG. 10 illustrates a side view of the holder enclosure 301 of the present invention. The holder enclosure 301 includes a cavity 303 for placement of the flexible holder 201. The holder enclosure 301 is substantially rectangular but could be other shapes to conform to the shape of the flexible holder 201. The holder enclosure 301 includes a living hinge 303 to allow the holder enclosure 301 to open to insert or remove the flexible holder 301 into the cavity 303.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. An oral hygiene device, comprising:
an enclosure having a plurality of recesses configured to fit adjacent to teeth of a wearer's mouth, and
at least one breath freshener disposed within the enclosure, configured to dissolve in saliva and release cleansing chemicals via the plurality of recess.

2. The device of claim 1, further comprises a holder integrally extending from the enclosure configured to engage between the teeth of the wearer.

3. The device of claim 1, further comprises a tab integrally extending from an end of the holder to secure the enclosure between the teeth of the wearer.

4. The device of claim 1, wherein the holder is made of a food grade polypropylene plastic.

5. The device of claim 3, wherein the tab is adapted to user's teeth conformation.

6. The device of claim 1, wherein the enclosure is formed by injection molding.

7. The device of claim 1, wherein the enclosure is made of polypropylene plastic.

8. The device of claim 1, wherein the enclosure is a chemical resistant material.

9. The device of claim 1, wherein the enclosure is made of a colorless translucent material.

10. The device of claim 1, wherein the breath freshener includes any one of an edible film, orally dissolving strip, chewing gum, tablet, lozenge, liquid, hard candy and a gel.
